(19) United States
(12) Patent Application Publication
(10) Pub. No.: US 2003/0003931 A1
(43) Pub. Date: Jan. 2, 2003

(54) Transmission of messages in telecommunication system

(75) Inventors: Marko Silventoinen, Jarvenpaa (FI); Seppo Kalliomaki, Vantaa (FI)

Correspondence Address: COHEN, PONTANI, LIEBERMAN & PAVANE, 551 FIFTH AVENUE, SUITE 1210, NEW YORK, NY, 10176, US

(73) Assignee: Sonera Oyj

(21) Appl. No.: 10/164,036

(22) Filed: Jun. 4, 2002

(30) Foreign Application Priority Data
Jun. 7, 2001 (FI) 20011209

(51) Int. Cl. H04Q 7/20

(52) U.S. Cl. 455/466; 455/414

(57) ABSTRACT

A method of transmitting messages with text-mode contents in a telecommunication system, and a telecommunication system comprising means for transmitting messages with text-mode contents from a sender to a receiver, a database containing at least one first character string containing at least one character, and at least one corresponding second character string containing at least one character, and message-editing means adapted to replace each second character string according to the database in the textual contents of the message with a corresponding first character string before the message is delivered to the receiver.

### BACKGROUND OF THE INVENTION

1. Field of the Invention

The invention relates to transmission of messages with text-mode contents in a telecommunication system and particularly in a mobile system, or in a telecommunication system comprising a mobile system.

2. Description of the Related Art

In addition to normal speech and data connections set up on traffic channels in digital mobile systems, short text-mode messages sent on system control channels can be transmitted between actual signaling. These messages are generally referred to as short messages. In order to implement short message service (SMS), mobile systems are provided e.g. with a short message service center that forwards short messages, and stores and resends short messages that have not been delivered. The short message service center can receive a short message via any network for transmission to a terminal, or a short message formed e.g. by means of a keypad from a terminal for delivery to another terminal or some other destination.

Short messages can be used e.g. to transmit text-mode information between mobile system subscribers. Short messages can also be used to provide subscribers with various text-mode services.

Writing of short messages with a limited keypad of a mobile station is typically slow and difficult. Furthermore, a length of a short message is usually rather limited, for example 160 characters. A possible solution to these problems is the use of various abbreviations. In other words, shortening the words to be transmitted in a short message can expedite, on the one hand, the time needed to create a short message and, on the other hand, enable more information to be fitted into a restricted message length. A problem with abbreviations is that the receiver does not necessarily understand their meaning.

A possible solution to this problem is use of well-known abbreviations. However, this arrangement restricts the use of abbreviations, since not all words have an established abbreviation. Furthermore, it still does not ensure that the receiver understands the abbreviation correctly since even common abbreviations may be open to interpretations or may have various meanings.

According to another prior art arrangement, a terminal can be provided with predictive input of text that facilitates and expedites particularly the input of text with a restricted keypad, thus reducing a need for abbreviations. A problem of this arrangement is that it does not eliminate the restriction on the message length, since the text is written out in full length already during the creation of the message.

### OBJECTS AND SUMMARY OF THE INVENTION

An objective of the invention is to provide a method and an apparatus implementing the method so as to eliminate the aforementioned problems. The objective of the invention is obtained by a method and a system that are characterized by what is disclosed in independent claims 1, 11 and 21. The preferred embodiments of the invention are disclosed in the dependent claims.

The invention is based on maintaining a database comprising definitions of correspondences between character strings, such as words and acronyms or synonyms, and replacing such character strings in the textual contents of a message to be transmitted that are found in the database with corresponding character strings before the message is delivered to the receiver. For example acronyms can thus be replaced with the corresponding full-length words.

The method and the system according to the invention have the advantage that a message can be written by means of abbreviations, which expedites the writing and enables more information to be fitted into the message. On the other hand, the receiver receives the message in an edited form, where e.g. abbreviations have been replaced with the corresponding words, whereupon the receiver does not have to know the abbreviations used.

According to a preferred embodiment of the invention, the contents of the database are at least partly specific to a sender, which means that the sender, such as a mobile system subscriber, can predetermine personal abbreviations and corresponding words, word groups or other character strings in the database. This enables the use of personal abbreviations or synonyms in writing of messages.

Furthermore, according to the preferred embodiment of the invention the contents of the database are at least partly specific to a receiver, i.e. the sender can predetermine receiver-specific abbreviations and corresponding words, word groups or other character strings in the database for use only in messages addressed to the receiver in question. This enables the use of receiver-specific messages or synonyms for writing messages, so that the same abbreviation can correspond to different words depending on the receiver of the message.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 shows a diagram of a telecommunication system according to an embodiment of the invention; and

FIG. 2 shows a structure of a database containing definitions of correspondences between character strings according to an embodiment of the invention.

### DETAILED DESCRIPTION OF THE PRESENTLY PREFERRED EMBODIMENTS

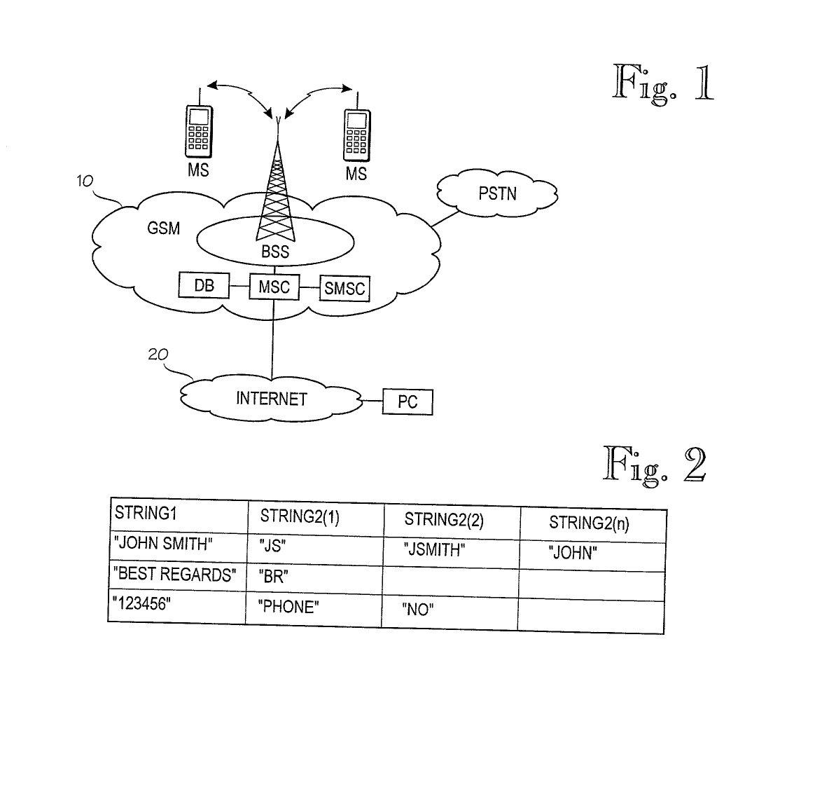

FIG. 1 shows an architectural diagram of a telecommunication system where the invention can be utilized. The telecommunication system shown in the figure comprises a mobile system 10 (PLMN, Public Land based Mobile Network), which is in this example a GSM (Global System for Mobile Communication), without restricting the invention thereto, however. The mobile system can also be e.g. a 3G system, such as a universal mobile communications system (UMTS), or then the telecommunication may comprise no mobile system at all. The GSM can also comprise services supporting more advanced protocols, such as GPRS (General Packet Radio Service) and WAP (Wireless Application Protocol). These services are available to users subscribing to the services and having a terminal that supports the services. A short message service center (SMSC) enables short message service in the mobile system and forwards short messages and stores and retransmits those short messages that have not been delivered. The SMSC can receive a short message via any network for transmission to a mobile station MS, and a short message formed e.g. by means of a keypad from a terminal for transmission to another terminal or to some other destination. A base station subsystem BSS provides an air interface for mobile stations MS to connect to the system. In this connection, a mobile station MS refers generally to a unit of a mobile subscriber and an actual terminal. A terminal can be any equipment able to communicate in the mobile system, or a combination of several terminals. The mobile system 10 is further connected e.g. to the Internet 20, to which a terminal PC, such as a personal computer, is also connected, and to a public switched telephone network PSTN. The details of the systems disclosed above are known to those skilled in the art and therefore need not be described in more detail.

Even though the invention is described by way of an example in connection with mainly short messages, the invention is not restricted thereto but it can be applied in connection with any messages containing text-mode or alphanumeric data. Examples of other applications of the invention include multimedia message service (MMS) and various Internet e-mail messages.

According to the invention, the telecommunication system comprises a database DB, which refers herein to a system element that includes not only the actual database but also means required to transmit data to/from the database. The database is situated e.g. in the mobile system 10 and it can be a separate component, as shown in FIG. 1, or it can be associated with the SMSC, for instance. The database DB can also be located elsewhere and connected to the system via the Internet, for example. Furthermore, there can be several databases, or the database can be divided into physically separate units. FIG. 2 shows an example of the contents of the database DB. The database DB contains definitions of correspondences between character strings, wherein one or more second character strings STRING2 (STRING2(1), STRING2(2), STRING2(n)) have been defined for each first character string STRING1 containing at least one character, the second character strings corresponding to the first character string. The character strings can contain letters, numerals, special characters and combinations thereof. Upper-case and lower-case letters can be processed as identical or different characters, depending on the situation.

Also according to the invention, in a message to be transmitted from a sender to a receiver in a telecommunication system each second character string STRING2 according to the database in the textual contents of the message is replaced with the corresponding first character string STRING1 before the message is delivered to the receiver. In the example of FIG. 1, for instance a short message from a mobile station MS to another mobile station MS or to an Internet terminal PC is transmitted by first inputting the message normally to the mobile station MS. The message can be input by means of the second character strings STRING2 contained in the database DB. An address used to transmit a short message to a receiver is usually the receiver's telephone number or some other corresponding identifier. Before the message is delivered to the receiver MS or PC, a system element performs the replacement of character strings according to the definitions in the database. This takes place by checking the character strings in the textual contents of the message and replacing each located second character string STRING2 according to the database DB with the corresponding first character string STRING1. For example, according to the database shown in FIG. 2, character strings ‘js’, ‘jsmith’ and ‘john1’ are replaced with the string ‘John Smith’ in the textual contents of the message. After all the located second character strings STRING2 have been replaced, the message with the edited textual contents is delivered to the receiver MS or PC. The message can thus be written by means of e.g. the abbreviation ‘js’, but the receiver reads from the message the corresponding character string ‘John Smith’. The replacement of character strings according to the invention is advantageous e.g. in SMS-based services, which operate by transmission of a service request in the form of a short message to a particular service number (service provider), the request containing different commands and parameters, on the basis of which the service, such as information on the weather, is obtained. It is thus possible to determine a long string of commands and parameters to correspond to an abbreviation of only one or a few characters, so that the use of the service requires the subscriber only to remember the predetermined abbreviation, which will be automatically replaced with the corresponding full-length character string before the message is delivered to the service provider.

The system element performing the replacement is preferably the short message service center SMSC or some other similar element responsible for transmission of messages. The replacement can also be performed e.g. by the transmitting terminal, such as a mobile station MS. The functionality according to the invention in the system element performing the replacement can be implemented by suitable software, for example.

Textual contents of a short message usually have a length of 160 characters. It is therefore possible that the textual contents of an original short message with a great number of abbreviations do not fit in a single short message after the replacement of character strings. According to a preferred embodiment of the invention, the textual contents are divided into two or more separate messages, which are delivered to the receiver if the length of the textual contents of the message exceeds the maximum length reserved for textual contents of one message as a result of the replacement of the character strings.

The definitions in the database DB concerning the correspondences between character strings STRING1 and STRING2 can be at least partly common, which means that they are applied to messages transmitted by any of the senders MS and PC. In addition thereto or alternatively, the definitions in the database DB concerning the correspondences between the character strings can be at least partly specific to a sender or a sender group, in which case the sender-specific or sender-group-specific definitions are only applied to messages transmitted by the sender in question or by a sender of the sender group in question. For example, the database DB can contain definitions according to which the character string ‘name’ is replaced with ‘John Smith’ in a message arriving from a particular sender MS or PC, but in a message from another sender the same string ‘name’ is replaced with string ‘Carol Jones’. Thus, the database can preferably be edited by a system user, such as a subscriber or some other sender MS or PC of messages. The database DB can be provided with a suitable connection and a user interface for making such sender-specific definitions. Access to the database for making definitions can be obtained e.g. via the Internet or the mobile system 10, depending on the system. A system user can make definitions concerning the correspondences between character strings STRING1 and STRING2 in the database DB in any manner he/she desires. It is also possible that the system suggests abbreviations or synonyms to certain words input by the user, or the abbreviations are formed according to a predefined principle. When the user is inputting definitions into the database, it is preferably checked that the definitions contain no contradictions, or if there are any contradictions, the user is alerted. In other words, for example a user is prevented from unintentionally determining two corresponding first character strings STRING1 for one and the same second character string STRING2, unless the user also determines different uses for the alternatives.

If the database DB contains both definitions common to all the users and sender-specific or sender-group-specific definitions, the common definitions are preferably applied only to the character strings that are not provided with any sender-specific or sender-group-specific definitions. Furthermore, according to a preferred embodiment of the invention the definitions contained in the database DB concerning the correspondences between the character strings can also be at least partly specific to a receiver or a receiver group, which means that such receiver-specific or receiver-group-specific definitions are only applied to messages to be delivered to the receiver in question or to a receiver of the receiver group in question. If the definitions in the database DB are both sender-specific and receiver-specific, the user (sender) can determine, in the database, personal character string correspondences that are dependent on the addressee of the message transmitted by the user. For example, a system user can determine that in messages to a particular receiver MS or PC, the character string ‘BR’ is replaced with the string ‘Best Regards’, whereas in messages transmitted to another receiver the same character string ‘BR’ is replaced with the string ‘Yours Sincerely’.

In the above examples, the term ‘sender’ or ‘receiver’ can refer to a mobile station MS or a terminal PC with a particular telephone number or some other corresponding subscriber identifier, or a subscriber or user using the MS or the terminal. When character strings are being replaced, the sender of the message, on the basis of which the replacement is performed, is identified e.g. based on the telephone number from which the message was transmitted. Correspondingly, the receiver is preferably determined during replacement according to an address related to the message, such as a telephone number or the like.

The replacement of character strings according to the invention is preferably carried out in response to an indication contained in a message for performing replacement. The indication can be e.g. a predetermined character or character combination contained in the textual contents, in which case the system element performing the replacement of character strings only carries out the replacement if the message comprises the agreed indication for replacement. The indication can be located either at the beginning or end of the textual contents, for example. The indication can also be included in signaling information possibly contained in the message. In such a case, the indication can be e.g. a particular predetermined parameter value or it can be included in the address data of the message. The telephone number or the like constituting the address of the short message can contain a predetermined additional number identified by the system transmitting the message, the number operating as an indication as described above for editing the textual contents of the message according to the invention. The message can also contain data on which of the alternative definitions contained in the database DB are to be applied to the message in question. For example, when the database comprises partly sender-specific and/or partly receiver-specific definitions, the indication can also contain data on the alternative definitions to be applied in the replacement of character strings. It is also possible that a system subscriber or some other sender of messages agrees in advance with the system provider on whether the service according to the invention is applied to the messages transmitted by the subscriber, and on the terms of the replacement. It is then possible to determine that the service is applied to every message or only to certain defined messages that fulfill predetermined conditions concerning the identity of the receiver, for instance.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A method of transmitting messages with text-mode contents in a telecommunication system comprising means for transmitting messages from a sender to a receiver, the method comprising:
maintaining a database containing at least one first character string containing at least one character, and at least one corresponding second character string containing at least one character; and
transmitting a message from a sender to a receiver, transmitting the message comprising:
replacing each second character string according to the database in the textual contents of the message with a corresponding first character string before delivering the message to the receiver.

2. The method of claim 1, wherein if the length of the textual contents to be transmitted exceeds the length reserved for textual contents of a single message as a result of the replacement of character strings, transmitting the message further comprises
dividing the textual contents into two or more separate messages; and
delivering all the messages to the receiver.

3. The method of claim 1, wherein the definitions contained in the database concerning the correspondences between the character strings are at least partly common, the common definitions being applied to messages transmitted by any of the senders.

4. The method of claim 1, wherein the definitions contained in the database concerning the correspondences between the character strings are at least partly specific to a sender or a sender group, the sender-specific or sender-group-specific definitions being applied only to messages transmitted by the sender in question or by a sender of the sender group in question.

5. The method of claim 3, wherein the common definitions are only applied to character strings with no sender-specific or sender-group-specific definitions.

6. The method of claim 1, wherein the definitions contained in the database concerning the correspondences between the character strings are at least partly specific to a receiver or a receiver group, the receiver-specific or receiver-group-specific definitions being applied only to messages to be delivered to the receiver in question or to a receiver of the receiver group in question.

7. The method of claim 1, wherein replacing every second character string is performed in response to an indication contained in the message to carry out the replacement.

8. The method of claim 7, wherein the definitions contained in the database concerning the correspondences between the character strings are at least partly specific to a sender or a sender group and/or at least partly specific to a receiver or a receiver group, said indication also containing data about the definitions to be applied in the replacement of character strings.

9. The method of claim 7, wherein the indication is contained in textual contents of a message.

10. The method of claim 7, wherein the indication is contained in address data of a message.

11. A telecommunication system comprising:
means for transmitting messages with text-mode contents from a sender to a receiver;
a database containing at least one first character string containing at least one character, and at least one corresponding second character string containing at least one character; and
message-editing means adapted to replace each second character string according to the database in the textual contents of the message with a corresponding first character string before the message is delivered to the receiver.

12. The telecommunication system of claim 11, wherein the message-editing means are adapted to divide the textual contents into two or more separate messages to be delivered to the receiver, if the length of the textual contents to be transmitted exceeds the length reserved for textual contents of a single message as a result of the replacement of character strings.

13. The telecommunication system of claim 11, wherein the definitions contained in the database concerning the correspondences between the character strings are at least partly common, and the message-editing means are adapted to apply the common definitions to messages transmitted by any of the senders.

14. The telecommunication system of claim 11, wherein the definitions contained in the database concerning the correspondences between the character strings are at least partly specific to a sender or a sender group, and the message-editing means are adapted to apply the sender-specific or sender-group-specific definitions only to messages transmitted by the sender in question or by a sender of the sender group in question.

15. The telecommunication system of claim 13, wherein the message-editing means are adapted to apply the common definitions only to character strings with no sender-specific or sender-group-specific definitions.

16. The telecommunication system of claim 11, wherein the definitions in the database concerning the correspondences between the character strings are at least partly specific to a receiver or a receiver group, and the message-editing means are adapted to apply the receiver-specific or receiver-group-specific definitions only to messages to be delivered to the receiver in question or to a receiver of the receiver group in question.

17. The telecommunication system of claim 11, wherein the message-editing means are adapted to replace each second character string in response to an indication contained in the message to carry out the replacement.

18. The telecommunication system of claim 17, wherein the definitions contained in the database concerning the correspondences between the character strings are at least partly specific to a sender or a sender group and/or at least partly specific to a receiver or a receiver group, said indication also containing data about the definitions to be applied in the replacement of character strings.

19. The telecommunication system of claim 17, wherein the indication is contained in textual contents of a message.

20. The telecommunication system of claim 17, wherein the indication is contained in address data of a message.

21. A telecommunication system element, the system comprising means for transmitting messages with text-mode contents from a sender to a receiver, and a database containing at least one first character string containing at least one character, and at least one corresponding second character string containing at least one character,
the telecommunication system element being adapted to replace each second character string according to the database in the textual contents of the message with a corresponding first character string before the message is delivered to the receiver.

22. The telecommunication system element of claim 21, adapted to divide the textual contents into two or more separate messages to be delivered to the receiver, if the length of the textual contents to be transmitted exceeds the length reserved for textual contents of a single message as a result of the replacement of character strings.

23. The telecommunication system element of claim 21, the definitions contained in the database concerning the correspondences between the character strings being at least partly common, and the telecommunication system element being adapted to apply common definitions to messages transmitted by any of the senders.

24. The telecommunication system element of claim 21, the definitions contained in the database concerning the correspondences between the character strings being at least partly specific to a sender or a sender group, and the telecommunication system element being adapted to apply the sender-specific or sender-group-specific definitions only to messages transmitted by the sender in question or by a sender of the sender group in question.

25. The telecommunication system element of claim 23, adapted to apply the common definitions only to character strings with no sender-specific or sender-group-specific definitions.

26. The telecommunication system element of claim 21, the definitions contained in the database concerning the correspondences between the character strings being at least partly specific to a receiver or a receiver group, and the telecommunication system element being adapted to apply the receiver-specific or receiver-group-specific definitions only to messages to be delivered to the receiver in question or to a receiver of the receiver group in question.

27. The telecommunication system element of claim 21, adapted to replace each second character string in response to an indication contained in a message to carry out the replacement.

28. The telecommunication system element of claim 27, the definitions contained in the database concerning the correspondences between the character strings being at least partly specific to a sender or a sender group and/or at least partly specific to a receiver or a receiver group, and said indication also containing data about the definitions to be applied in the replacement of character strings.

29. The telecommunication system element of claim 27, the indication being contained in textual contents of a message.

30. The telecommunication system element of claim 27, the indication being contained in address data of a message.

31. The telecommunication system element of claim 21, which is a short message service center.

32. The telecommunication system element of claim 21, which is a mobile station.
